(19) United States
(12) Patent Application Publication
(10) Pub. No.: US 2018/0239571 A1
(43) Pub. Date: Aug. 23, 2018

(54) SYSTEM AND METHOD FOR AUTOMATED ASSIGNMENT AND BALANCE OF DOCUMENT PROCESSING DEVICE COLLECTORS

(71) Applicants: Kabushiki Kaisha Toshiba, Minato-ku (JP); Toshiba TEC Kabushiki Kaisha, Shinagawa-ku (JP)

(72) Inventors: Marianne Kodimer, Huntington Beach, CA (US); Surya Ravichandran, Mission Viejo, CA (US)

(21) Appl. No.: 15/440,711

(22) Filed: Feb. 23, 2017

(51) Int. Cl. G06F 3/12

(52) U.S. Cl. CPC G06F 3/1259; G06F 3/1291; G06F 3/1262

(57) ABSTRACT

A system and method for automated network device group collector management includes a memory storing device management data for each of the document processing devices. A processor receives updated device management data corresponding to a device change in an identified device group and designates a document processing device in the identified group as a group primary collector in accordance with received updated device management data. The processor communicates device management data comprising primary collector designator data to a selected document processing device in the identified group via the network interface. A second document processing device may be designated as a secondary collector and a load sharing or balancing between collectors is made. Assignment of roles and loads is communicated to devices via the network.

### TECHNICAL FIELD

This application relates generally to automated administration or monitoring of document processing devices. The application relates more particularly to assignment of one or more document processing devices to monitor and report device activity for a device group.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Earlier installations would involve businesses buying one or more MFPs. Given the expense in obtaining and maintain MFPs, devices are frequently shared or monitored by users or technicians via a data network. MFPs, while moveable, are generally maintained in a fixed location. MFP devices are complex and in need of regular restocking or servicing. Earlier on, these functions were accomplished by on-site technicians by larger companies, or with service calls to service companies for smaller installations.

More recently, companies lease office machines, such as MFPs, from third party providers. In certain scenarios, total cost of a device may be calculated by a negotiated, per-page charge. Monitoring of device usage may be made by looking at device counters, job logs or consumable levels on a device itself. More recently, administration and monitoring of MFPs is done by a networked computer designated as a monitor or data collector. Collection of device usage information or consumable usage information such as paper usage, toner or ink usage, is assigned to a dedicated administrative computer. Information collected by the administrative computer can be used to reorder supplies, schedule device maintenance and calculate usage charges to be assessed to a person or company.

### SUMMARY

In accordance with an example embodiment of the subject application, a system and method for a network device group collector management includes a memory storing device management data for each of the document processing devices. A processor receives updated device management data corresponding to a device change in an identified device group and designates a document processing device in the identified group as a group primary collector in accordance with received updated device management data. The processor communicates device management data comprising primary collector designator data to a selected document processing device in the identified group via the network interface.

### BRIEF DESCRIPTION OF THE DRAWINGS

Various embodiments will become better understood with regard to the following description, appended claims and accompanying drawings wherein:

FIG. 1 an example embodiment of a managed device network;

FIG. 2 is an example embodiment of a document rendering system;

FIG. 3 is an example embodiment of a digital device;

FIG. 4 is an example embodiment of a device move between groups;

FIG. 5 is an example embodiment of a server reassignment of collector responsibility;

FIG. 6 is an example embodiment of networked device groups;

FIG. 7 is an example embodiment of a software module diagram; and

FIG. 8 is an example embodiment of a flowchart for device server operation.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

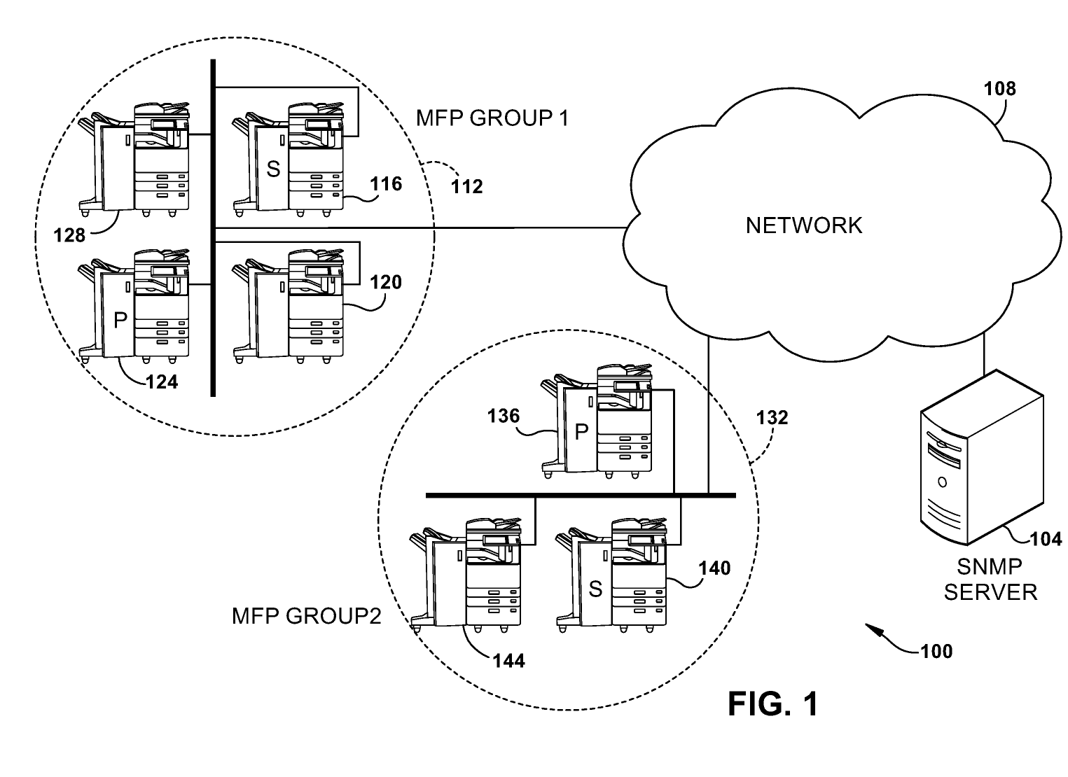

In accordance with the subject application, FIG. 1 illustrates an example embodiment of a managed device network 100 for assigning one or more device data collectors for each of a plurality of device groups. One or more servers, such as device server 104, is in data communication with a plurality of device groups via network 108. Network 108 is suitably comprised of a local area network (LAN), wide area network (WAN), which may include the global Internet, or any suitable combination thereof. In the example of FIG. 1, network 108 is associated with MFP GROUP 1, 112 comprised of MFPs 116, 120, 124 and 128. Network 108 is also associated with MFP GROUP 2, 132 that includes MFPs 136, 140 and 144. Device server 104 is provided with any suitable device management or communication system, such as eBRIDGE CloudConnect (ECC) of Toshiba TEC.

As discussed above, earlier systems have used a dedicated server to monitor activity on a plurality of MFP devices. While effective, use of such a dedicated server has several disadvantages. A first disadvantage is that such a system requires the purchase and maintenance of dedicated server hardware and software. A second disadvantage is that a dedicated server provides a single point of failure. If a server were to fail, lose power or lose network connectivity, then device monitoring would be ended or suspended. In business models in which cost is based on page count, there could be lost revenue or lost time value of money for the time when the server is out of commission. Implementation of a backup server might alleviate some of the problems but could double the cost of server hardware, software and maintenance. Of course, there is also a chance that a backup server could also fail, lose power or lose network connectivity.

In accordance with an example embodiment of the subject application, an intelligent device controller, such as may be found on more modern MFPs, is provided with added functionality so that it may also take on a role of what would have been a dedicated device server. Current device controllers comprise computer functionality and may typically have sufficient hardware, software and network resources available to them to take on this added role. Given that MFP hardware and software is already being used for document processing tasks, it may be advantageous to limit monitoring duties to a relatively small group of devices, such as a group of devices located on the same floor or same building, while the monitoring device reports to a server tasked with receiving reporting from multiple devices in multiple device groups. In addition to the forgoing, MFP devices may be relatively frequently removed, replaces or moved to another work group. This can be problematic when a device is serving the added role of a device collector.

In the example embodiment of FIG. 1, each MFP group has one MFP device assigned to be a device server. MFP 124 is assigned as a primary device collector for group 112 and MFP 136 is assigned as primary device collector for group 132. As an added layer of redundancy, a second MFP from each group is assigned as a secondary or backup device collector. MFP 116 serves this role for group 112 and MFP 140 serves this role for group 132. Device server 104, suitably using any suitable network management protocol, such as Simple Network Management Protocol (SNMP), has network access to all MFPs of group 112 and group 132.

In an example embodiment employing SNMP, MFP devices expose management data in their internal management information base (MIB) which is accessible by device server 104, or SNMP server as illustrated, which can read from and write to their MIBS. Thus, device server 104 can designate a device as a primary server or a secondary server, move servers between groups, decommission devices or introduce a new collection device. Device server 104 may also balance loads between two or more MFPs serving a collector role. Device server 104 suitably detects user activity on MFP devices as a trigger point to check device activity levels, assign or reassign server functions or institute a load balancing when desirable.

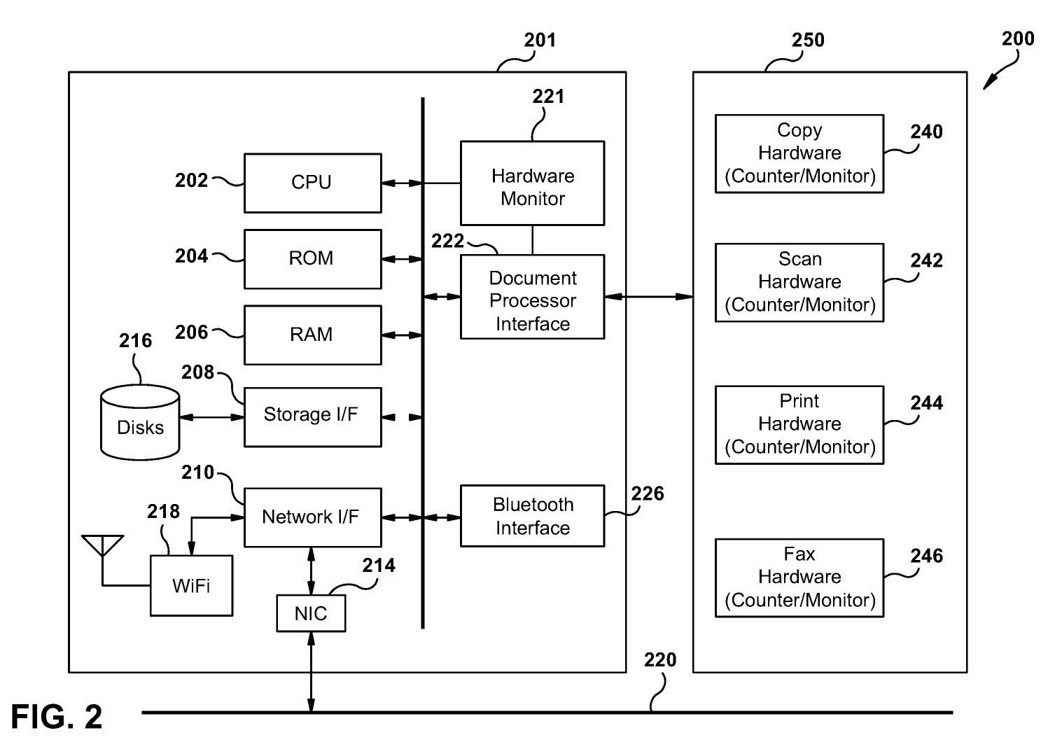

Turning now to FIG. 2, illustrated is an example embodiment of a document rendering system 200 suitably comprised within an MFP, such as with MFPs 116, 120, 124, 128, 136, 140 and 144 of FIG. 1. Included is controller 201 comprised of one or more processors, such as that illustrated by processor 202. Each processor is suitably associated with non-volatile memory such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 202 can also be in data communication with any suitable user input/output (I/O) interface which provides data communication with user peripherals, such as displays, keyboards, mice, track balls, touch screens, or the like. Hardware monitor 221 suitably provides device event data, working in concert with suitably monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 216.

Also in data communication with data bus 212 is a document processor interface 222 suitable for data communication with MFP functional units 250. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

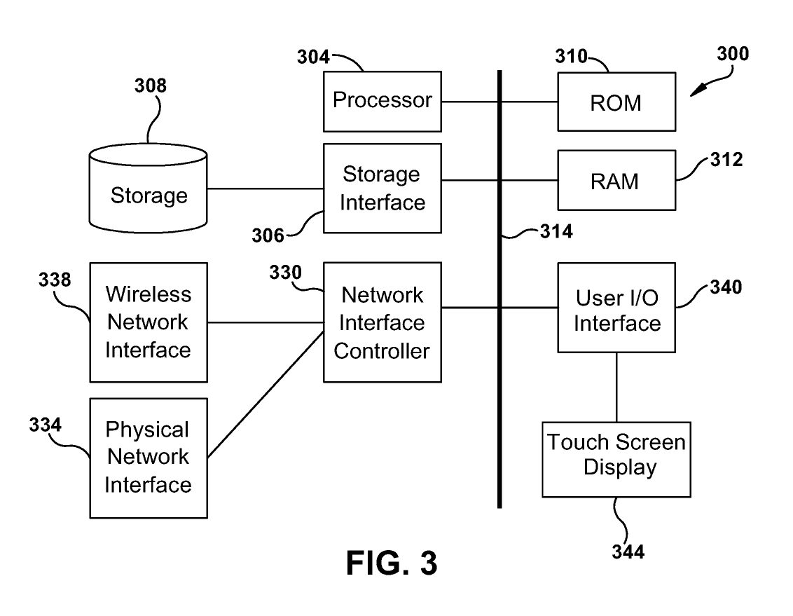

Turning now to FIG. 3, illustrated is an example embodiment of digital devices, including device server 104 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to a physical, such as a wired or optical network connection via physical network interface 334, or to any suitable wireless data network connection via wireless network interface 338, such as one or more of the networks detailed above. Processor 304 is also in data communication with a user input/output (I/O) interface 340 which provides data communication with user peripherals, such as touchscreen display 344, keyboards, trackballs, video displays, mice or the like. It will be understood that functional units are suitably comprised of intelligent units, including any suitable hardware or software platform.

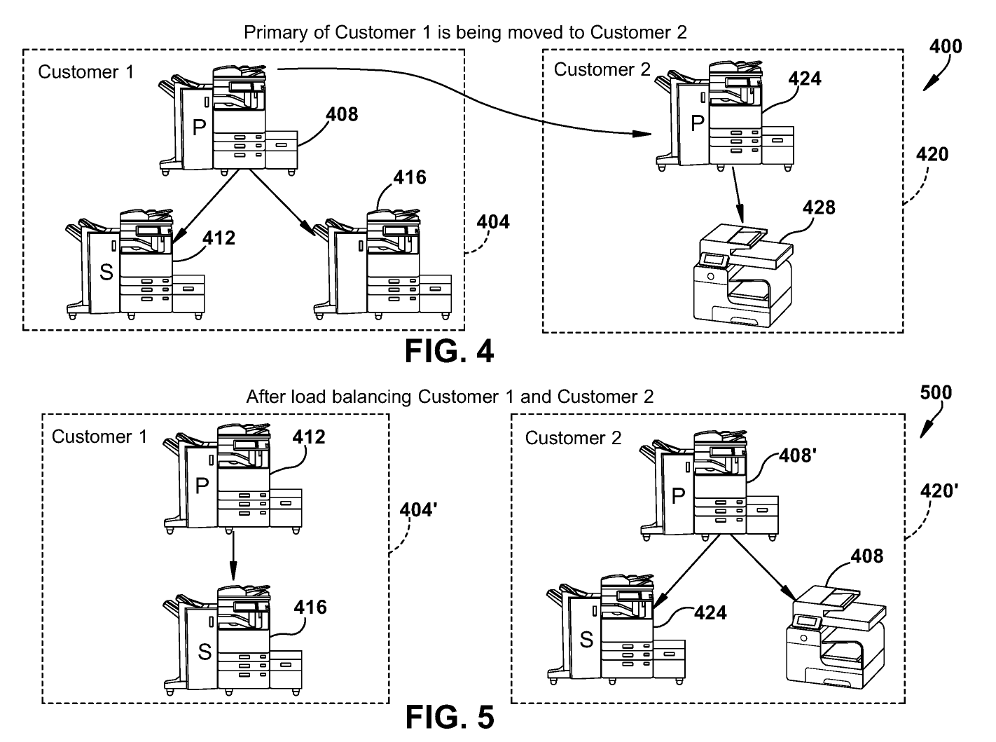

FIG. 4 illustrates an example embodiment of a device move between groups wherein Customer 1 has an MFP group 404 comprising MFPs 408, 412 and 416. MFP 408 is designated as a primary collector and MFP 412 is designated as a secondary collector. Customer 2 has a group 420 comprising two devices, MFP 424 and printer 428. MFP 424 is designated a primary collector. There is no secondary collector in group 420 insofar as printer 428 does not have sufficient capability to serve as a collector in this example. In the illustrated example, primary collector MFP 408 of group 404 is moved to group 420 and the associated device server (not shown) discovers this modification or is otherwise placed on notice of such a transition. With this move, group 404 no longer has a primary collector and group 420 now has another device capable as functioning as a collector. Group 404 has two devices, both of which are capable of functioning as a collector, after the device move. Immediately after moving MFP 408 from group 404 to group 420 and pending any reassignment, secondary collector MFP suitably take over all responsibility for collection previously handled by MFP 408 and MFP 424 continues to handle collection for group 420.

Referring next to FIG. 5, illustrated is an example embodiment of server reassignment of collector responsibility after move of MFP 408 as illustrated with FIG. 4, above. Modified group 404′ no longer includes MFP 408 which now appears as MFP 408′ in modified group 420′. The associated device server (not shown) suitably assigns primary and secondary collector duties between MFPs 412 and 416. In the illustrated example, MFP 412 takes over (or maintains after taking over from MFP 408) primary collector responsibility and secondary collector responsibility is assigned to MFP 416. Such designation is suitably chosen by the device server on the basis of respective capabilities or workloads of MFPs 412 and 416. In other examples, it may be advantageous for the device server to assign opposite primary and secondary collector responsibilities. The device server also suitably communicates load sharing or balancing responsibilities between MFPs 412 and 416, such as in accordance with their respective capabilities or workloads.

Modified group 420′ now includes MFPs 408′ and 424 with collector capability. The device server suitably designates MFP 408′ as primary collector and shifts the responsibility of MFP 424 from primary collector to secondary collector. As noted above with group 404′, in other example embodiments the device server may determine it beneficial to retain primary collector responsibility with MFP 424 and assign newly acquired MFP 408′ with secondary collector responsibility, such as based on device capability or workload. As with group 404′, the device server also suitably instructs a load sharing or balancing responsibilities between MFPs 408′ and 424.

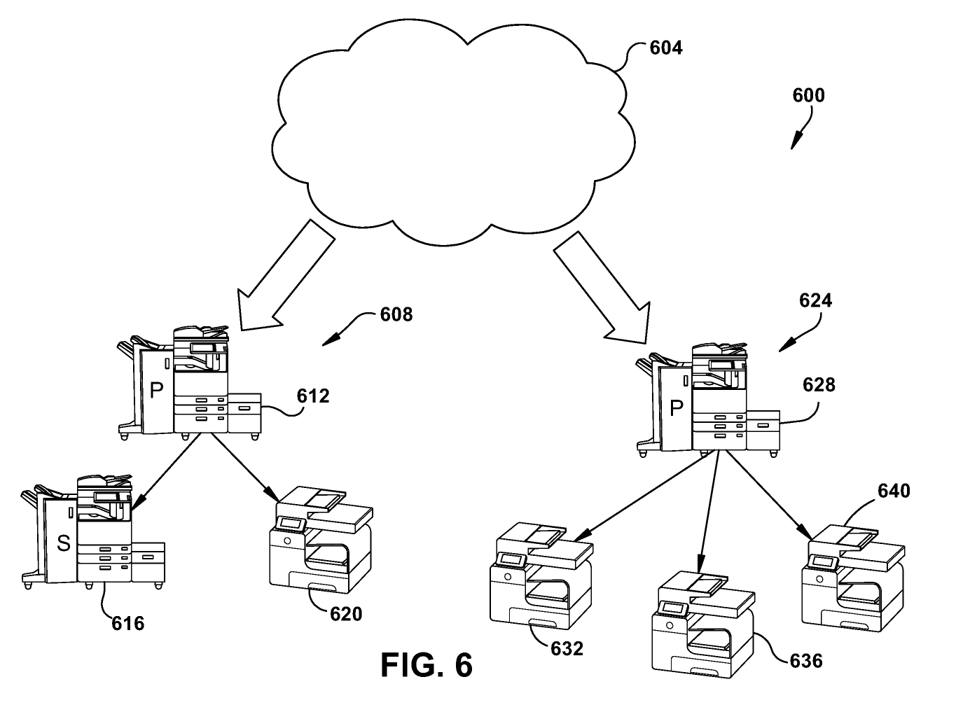

FIG. 6 illustrates an example embodiment of networked device groups 600. Included is group 608 having MFP 612 designated as a primary collector, MFP 616 designated as a secondary collector, and printer 620. Also included is group 624, including primary collector MFP 628 and printers 632, 636 and 640. A device server (not shown) has an option to designate two MFPs of group 608 as collectors and suitably selects MFP 612 as a primary due to device capability or workloads while designating MFP 616 as a secondary collector. As with the example embodiments described above, the device server suitably executes a collector load sharing or balancing between the devices. As to group 624, only MFP is capable of functioning as a collector and the device server therefore assigns it with all collection responsibilities with no backup, load sharing or load balancing assistance from any other device in the group. In other example embodiments, it may be desirable to have some or all of collector responsibilities shared between groups, such as via network 604. By way of example, secondary collector MFP 616 of group 608 may also serve as a secondary collector for group 624. The device server may suitably rebalance or reallocate collector responsibilities between with primary collector 612 to accommodate the additional workload on MFP 616.

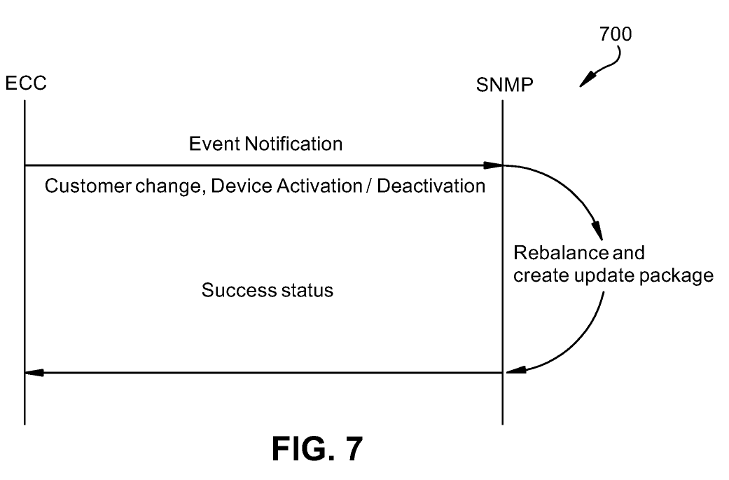

Turning next to FIG. 7 is an example embodiment of a software module diagram 700 in connection with realization of example embodiments disclosed herein as suitably run on a device server such as an ECC cloud server. Event notification such as customer change, device activation or device deactivation is communicated with a cloud server, suitably by SNMP communication with MFP devices. Such an event causes assignment or reassignment of primary collector responsibility, assignment or reassignment of secondary collector responsibility, or setting of load balancing or load sharing among collector devices.

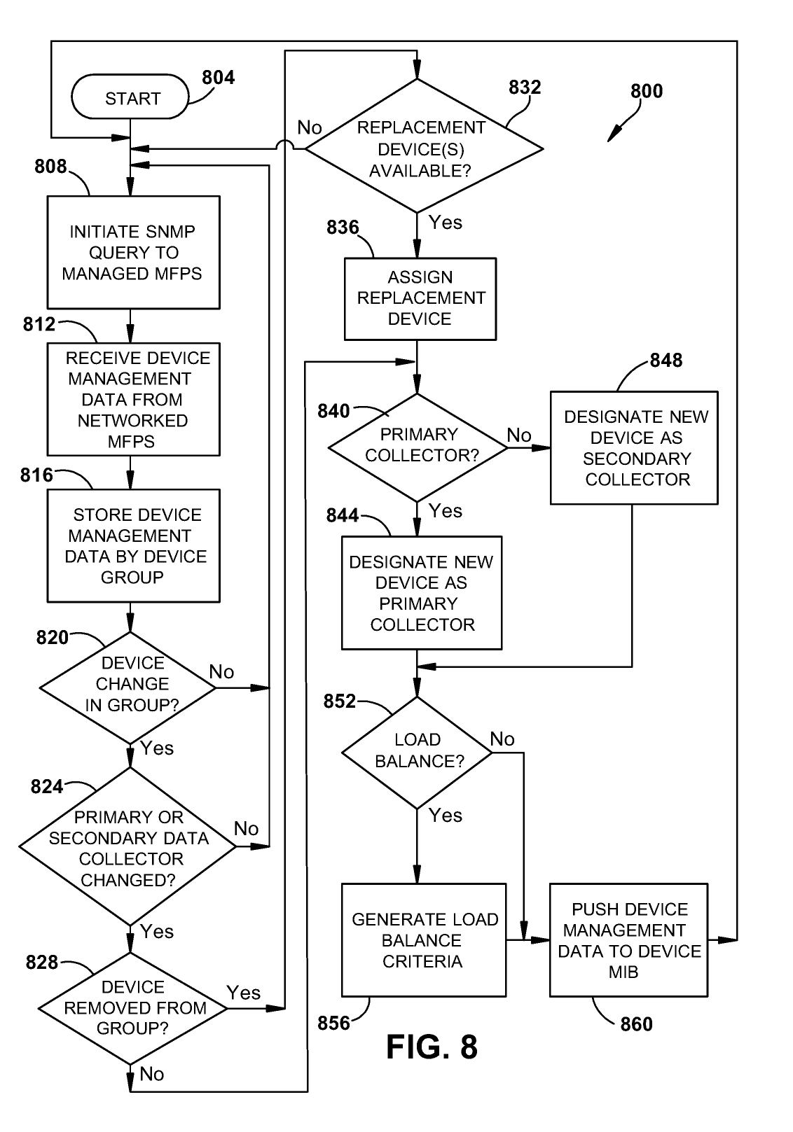

Referring now to FIG. 8, illustrated is an example embodiment of a flowchart 800 for operation of a device server, such as device server 104 of FIG. 1. The process commences at block 804 and an SNMP query is issued to managed MFPs at block 808. Device management data from manage MFPs, such as via communication with device MIBs, is obtained at block 812 and stored at block 816. A determination as to whether a group device was changed is made at block 820. If there is no change in devices within a managed group, the process suitably returns to block 808. If there is a triggering event, then a determination is made at block 824 whether a primary or secondary collector device has been changed. If not, the process returns to block 808. If so, a determination as to whether replacement devices are available is made at block 832. If not, the remaining primary collector, or secondary collector now serving as a primary collector, is maintained and the process returns to block 808. If another capable device is present, a replacement device is assigned at block 836. If it is determined that a primary collector was removed at block 840, then the replacement device is assigned that role at block 844. If a secondary collector was removed, then the new device is assigned a secondary collector role at block 848. After role assignment, a determination is made at block 852 as to whether a load balance is to be made between collectors. If so, load balance criteria are determined at block 856 and progress is made to block 860 with load balance criteria. If not, progress is made to block 860 without load balance criteria. Management data is then pushed to managed MFPs regarding role assignment and/or load balancing at block 860 and the process returns to block 808.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A device comprising:
a network interface configured to communicate device management data with each of a plurality of document processing devices in each of a plurality of document processing device groups;
a memory storing device management data for each of the document processing devices; and
a processor configured to
receive updated device management data corresponding to a device change in an identified device group,
designate a document processing device in the identified group as a group primary collector in accordance with received updated device management data, and
communicate device management data comprising primary collector designator data to a selected document processing device in the identified group via the network interface.

2. The device of claim 1 wherein the processor is further configured to designate a second document processing device in the identified group as a group secondary collector in accordance with received updated device management data, and
wherein the processor is further configured to communicate device management data comprising secondary collector designator data to a second selected document processing device in the identified group via the network interface.

3. The device of claim 2 wherein the processor is further configured to generate load balancing data corresponding to a load balancing between the group primary collector and the group secondary collector, and
wherein the processor is further configured to communicate device management data including the load balancing data to the group primary collector and the group secondary collector via the network interface.

4. The device of claim 3 wherein the processor is further configured to communicate the device management data by accessing a management information base on each document processing device via the network interface.

5. The device of claim 4 wherein the updated device management data includes data corresponding to a removal of a document processing device from the identified group.

6. The device of claim 4 wherein the updated device management data includes data corresponding to an addition of a document processing device from the identified group.

7. The device of claim 4 wherein the updated device management data includes data corresponding movement of a repositioned document processing device from the identified group to a second identified group,
wherein the processor is further configured to receive updated device management data corresponding to the repositioned document processing device via the network interface,
wherein the processor is further configured to designate a document processing device in the second identified group as a second group primary collector in accordance with received updated device management data, and
wherein the processor is further configured to communicate device management data comprising a second group primary collector designator data to a selected document processing device in the identified group via the network interface.

8. A method comprising:
communicating device management data with each of a plurality of document processing devices in each of a plurality of document processing device groups via a network interface;
storing device management data for each of the document processing devices in a memory;
receiving updated device management data corresponding to a device change in an identified device group via the network;
designating, via an associated processor, a document processing device in the identified group as a group primary collector in accordance with received updated device management data; and
communicating device management data comprising primary collector designator data to a selected document processing device in the identified group via the network interface via the network interface.

9. The method of claim 8 further comprising:
designating, via the processor, a second document processing device in the identified group as a group secondary collector in accordance with received updated device management data; and
communicating device management data comprising secondary collector designator data to a second selected document processing device in the identified group via the network interface.

10. The method of claim 9 further comprising:
generating, via the processor load balancing data corresponding to a load balancing between the group primary collector and the group secondary collector; and
communicating device management data including the load balancing data to the group primary collector and the group secondary collector via the network interface.

11. The method of claim 10 further comprising communicating the device management data by accessing a management information base on each document processing device via the network interface.

12. The method of claim 11 wherein the updated device management data includes data corresponding to a removal of a document processing device from the identified group.

13. The method of claim 11 wherein the updated device management data includes data corresponding to an addition of a document processing device from the identified group.

14. The method of claim 11 wherein the updated device management data includes data corresponding movement of a repositioned document processing device from the identified group to a second identified group and further comprising:
receiving receive updated device management data corresponding to the repositioned document processing device via the network interface;
designating, via the processor, a document processing device in the second identified group as a second group primary collector in accordance with received updated device management data; and
communicating device management data comprising a second group primary collector designator data to a selected document processing device in the identified group via the network interface.

15. A device comprising:
a document processing controller, including a processor and memory, configured to monitor and control operation of a multifunction peripheral, and collect internal device data corresponding to document processing operations on the multifunction peripheral;
a memory configured to store a management information base, including device management data, corresponding to a current state of the multifunctional peripheral; and
a network interface configured to communicate device management data between the management information base and an associated server,
wherein the controller is further configured to receive into the management information base via the network interface, designator data designating the controller as a data collector for an identified group of multifunction peripherals,
wherein the controller is further configured to receive, responsive to received designator data, external device operation data for the identified group of multifunction peripherals, and
wherein the controller is further configured to store internal and external device operation data in the memory.

16. The device of claim 15 wherein the controller is further configured to receive into the management information base via the network interface, load balancing data corresponding to a load balancing between the controller and a second multifunction peripheral in the identified group, and
wherein the controller is further configured to selectively process external device operation data in accordance with received load balancing data.

17. The device of claim 16 wherein the controller is further configured to communicate device status data with the second multifunction peripheral via the network interface.

18. The device of claim 17 further comprising the controller configured to generate group report data comprising the internal and external device operation data in accordance received device status data.

19. The device of claim 15 wherein the controller is further configured to generate group report data comprising the internal and external device operation data in accordance when the designator data designates the controller as a primary data collector.

20. The device of claim 15 wherein the controller is further configured for SNMP communication of device management data.
